(19) United States
(12) Patent Application Publication
(10) Pub. No.: US 2025/0034041 A1
(43) Pub. Date: Jan. 30, 2025

(54) PROCESS

(71) Applicant: ST Equipment & Technology LLC, Needham, MA (US)

(72) Inventors: Peter Anil Rodricks, Normanhurst (AU); Abhishek Gupta, Cambridge, MA (US)

(21) Appl. No.: 18/713,432

(22) PCT Filed: Dec. 7, 2022
(86) PCT No.: PCT/IB2022/061878

§ 371 Date: May 24, 2024

(30) Foreign Application Priority Data
Dec. 8, 2021 (AU) 2021903968

(51) Int. Cl. C04B 14/06

(52) U.S. Cl. CPC C04B 14/068

(57) ABSTRACT

There is provided a method for reducing the amount of silica in a desert sand of a type that also comprises calcium carbonate, iron oxide and alumina components, to thereby produce a cement raw material feedstock, the method comprising: imparting a net negative electrical charge to a silica component and a net positive electrical charge to a calcium carbonate component of the desert sand through interparticle friction by a triboelectrostatic mechanism; and applying an electric field to the charged components of the desert sand by a triboelectrostatic mechanism; such that the negatively charged silica component is separated from a remainder of the components of the desert sand to thereby produce the cement raw material feedstock.

### TECHNICAL FIELD

This disclosure relates to a method and system for reducing the amount of silica in a desert sand of a type that also comprises calcium carbonate, iron oxide and alumina components. By reducing the amount of silica by a triboelectrostatic mechanism, the method and system is able to produce a cement raw material feedstock. This disclosure also relates to the use of such desert sands in the production of cements.

### BACKGROUND ART

Cement is the most widely used binding agent in construction for housing and infrastructure, particularly in the production of concrete. Limestone is the major raw material in cement manufacture, comprising up to 80% by weight, and is composed principally of calcium carbonate (CaCO₃). Limestone is a carbonate sedimentary rock and its major constituents are the minerals calcite and aragonite, which are different crystal forms of calcium carbonate (CaCO₃). Industrial quantities of limestone are obtained by mining limestone rock from quarries, which is then crushed and ground in energy intensive comminution operations. For cost and logistics efficiencies, cement plants are often located near limestone quarries and, in the case of integrated cement plants, the manufacturer gains access to a captive quarry to meet its long-term requirements, typically for a period of 25 to 30 years, being the life cycle of the cement plant.

In most cases, cement plants worldwide are designed around the utilisation of quarried limestone as the raw material for the essential calcium carbonate mineral, which is calcined to produce lime for cement production. Other essential minerals for the cement raw material are added to the lime, typically in the form of iron ore, shale, clay and alumina.

The typical limestone quarry process commences with the blasting of limestone rock with explosives, loading of the liberated material with an assortment of heavy mining equipment and hauling the rock to the cement plant. The conditions typical of limestone quarries create a working environment that requires a high degree of caution by workers to maintain safety, as well as high wear and tear on the heavy machinery employed on the site. These conditions steadily worsen as the quarry terrain complexity grows over the lifetime of the quarry.

The quarried limestone is crushed, ground and homogenised with clay, sand and iron ore in precise proportions to form the “raw meal” or “raw mix” for cement production, the raw meal or mix containing calcium carbonate (CaCO₃), silica (SiO₂), iron oxide (Fe₂O₃), alumina (Al₂O₃), magnesium oxide (MgO) and other trace minerals. The trace minerals each comprise below 1% by weight of the raw meal and typically include potassium oxide (K₂O), sodium oxide (Na₂O), titanium dioxide (TiO₂), sulphur trioxide (SO₃) and chromium oxide (Cr₂O₃), among others.

The raw meal is homogenised, including a reduction in particle size to 50-100 microns, and is fed into a large rotary kiln where it sinters at 1450° C. to produce 3-25 mm sized nodules of sintered material, known as cement clinker. Once cooled in a precisely controlled process, the clinker is ground with gypsum and/or other additives to produce Ordinary Portland Cement (OPC) and other speciality cements.

A typical analysis of the raw meal from a mix of limestone, shale, clays, sand and iron ore is CaO 42-43 wt. % (equivalent to 75-77 wt. % CaCO₃), SiO₂ 13-14 wt. %, Al₂O₃ 3.5-4 wt. %, Fe₂O₃ 2-2.5 wt. %, MgO 1-2 wt. % plus trace elements inherent in the raw materials. Deleterious minerals such as sulphates and chlorides in the raw meal must be kept below levels set by industry standards for given types of cement.

The limestone quarrying process uses significant water in spray and dust suppressant systems to manage particulate dust pollution and mitigate health risks for workers and populations in surrounding areas. Quarries in desert regions face acute shortage of fresh water to meet these needs.

It is estimated that 70% of energy usage in cement plants is expended on particle comminution or size reduction of quarried limestone and clinker raw material. The preparation process after limestone rocks are crushed, prior to raw meal homogenisation, is a complex process known as ‘pre-homogenisation’, which occupies a large physical area within the cement plant.

With the cement manufacturing industry currently making only incremental efficiency improvements year-on-year, innovation, digitalisation and sustainability hold the biggest potential for major improvements to the cement production process. Most major global cement producers have the stated goal of applying so called ‘Industry 4.0’ methodologies; essentially the computerisation and automation of cement manufacture. Thus, there is also a need to apply digitalisation and process automation to sustainably redesign and redefine the traditional cement plant.

AU 663225 and AU 200215570 disclose separation processes for limesands. This material differs fundamentally from desert sands in geological origin, composition and degree of liberation of calcium carbonate, with limesands being made up of fragments of shells mixed with quartz silica. In contrast, desert sands originate from erosion, decomposition, weather change and, in contradistinction to limesands, have unexpectedly been noted to contain useful quantities or alumina, iron oxide and magnesium oxide, all essential components in cement raw material feeds. However, the desert sand particles, being intimately mingled agglomerates of calcium carbonate and other minerals, are not well liberated, especially when compared with limesands, with the calcium carbonate, silica and other minerals typically being coated with iron oxide and clays. Thus, the separation techniques for limesands are not applicable to the separation of components, such as silica, from desert sands. In this regard, skilled persons in the field readily identify the fundamental physical and mineralogical differences between limesands and desert sands, with such differences having been validated by available XRF analysis reports.

In this regard, AU 663225 discloses the specific objective of producing a raw material for quicklime production, from limestone or limesand. The electrostatic separation process disclosed in AU 663225 describes the application of only a positive electrode, in a free-fall type separator design, disclosing in reference to FIGS. 1a, 1b and 1c, that “the plates 12 and 14 are each connected to a high voltage DC power supply (not shown) in a manner that plate 14 is connected to high voltage-positive polarity and plate 12 is connected to earth”. AU 663225 further notes “For example, the plate may be connected to the high voltage-positive polarity whilst the roller is connected to earth”. Significantly, AU 663225 does not rely on electrostatic particle charging imparted by interparticle friction between principal components of the feed material.

It is further noted that the method disclosed in AU 663225 using limesand feedstocks, and currently utilised commercially in the processing of limesand feeds, is not suitable for the separation of a component such as silica from desert sand. In this regard, when the method disclosed in AU 663225 is applied to samples of desert sand it fails to produce a required separation on such samples, noting also that desert sand contains a number of components in addition to calcium carbonate and silica. Furthermore, the method of AU 663225 requires a very high voltage application (i.e. 15 kV) to produce the electric field required for separation. In addition, the method of AU 663225 is unable to separate particle sizes under 100 microns, requiring additional processes and considerable wastage of feedstock, if applied to a typical desert sand.

AU 200215570 discloses a production process for quicklime from a limesand feed, where the quicklime product has a silica content of less than about 2%. The electrostatic process disclosed in AU 200215570 is not described in detail and there is no disclosure of a triboelectrostatic process, or friction imparted charging of particles to be separated. Rather, AU 200215570 discloses a method of treating limesands having a wide range of unevenly divided particle sizings (as much as 5:1), by a classification process into four fractions, for a four-kiln calcination processes. A skilled person in the field will readily discern the differences in limesand from desert sand and appreciate that the process disclosed in AU 200215570 cannot be applied to desert sands, due in part to the narrow range of particle sizes of desert sands, rendering classification into four fractions impossible and unnecessary. Furthermore, AU 200215570 makes no disclosure of the methodology or apparatus of the electrostatic separation stages.

GB 536586 discloses a method of producing cement raw material by a water-based slurry method. Such water-based methods cannot be applied to electrostatic separation techniques. Furthermore, only dry cement production plants operate in desert regions, where water is scarce. A water-based process such as disclosed in GB 536586 could not be practically employed for desert sand feedstocks.

U.S. Pat. No. 3,143,492 discloses a method for vertical, gravity fed electrostatic separation of various materials including an indeterminate “sample of calcite contaminated with natural gangue material, consisting of quartz and dark, slatey mineral, probably silicates”. The output material is not disclosed in detail, with U.S. Pat. No. 3,143,492 noting that “no analysis other than visual inspection were made of the feed and separated fractions”. A primary objective of U.S. Pat. No. 3,143,492 is the production of a material having a visual appearance of ‘whiteness’ such that the separated material can be used in the paints and plastics industry as a filler. As with AU 663225, it is observed that the process of U.S. Pat. No. 3,143,492 has significant difficulty in separating particle sizes under 75 microns. Furthermore, a single charging of the material prior to three consecutive stages of separation is noted to be an inherent weakness of the system, because the triboelectrostatic charge would tend to decay through such a process. Like AU 663225, U.S. Pat. No. 3,143,492 also requires a high voltage to be applied on electrodes in each of the three separation stages. Significantly, tests carried out using the method and apparatus of U.S. Pat. No. 3,143,492 with desert sands, failed to achieve effective separation of the component materials.

BITTNER, J. D. et al., (‘Triboelectric belt separator for beneficiation of fine minerals’, Procedia Engineering, 2014, vol 83, pages 122-129) discloses a triboelectric separator used to beneficiate particular minerals. BITTNER, J. D. et al. does not disclose or suggest the use of desert sands to produce a cement raw material feedstock. The document is primarily directed to the beneficiation of coal combustion fly ash for cement production. Table 3 discloses a calcium carbonate/silica separation process, however, the feed composition clearly notes “90.5% CaCO₃/9.5% SiO₂”, which is markedly different from the composition of a desert sand contemplated by the present disclosure. In this regard, skilled persons in the field would readily identify the fundamental physical and mineralogical differences between calcium carbonate-rich feeds and desert sands.

It is to be understood that, if any prior art is referred to herein, such reference does not constitute an admission that the prior art forms a part of the common general knowledge in the art, in Australia or any other country.

### SUMMARY

In one aspect there is provided a method for reducing the amount of silica in a desert sand of a type that also comprises calcium carbonate, iron oxide and alumina components, to thereby produce a cement raw material feedstock.

In one aspect there is provided a method for reducing the amount of silica in a desert sand of a type that also comprises calcium carbonate, iron oxide and alumina components, to thereby produce a cement raw material feedstock, the method comprising:
imparting a net negative electrical charge to a silica component and a net positive electrical charge to a calcium carbonate component of the desert sand through interparticle friction by a triboelectrostatic mechanism; and
applying an electric field to the charged components of the desert sand by a triboelectrostatic mechanism;
such that the negatively charged silica component is separated from a remainder of the components of the desert sand to thereby produce the cement raw material feedstock.

In one aspect there is provided a cement raw material feedstock comprising calcium carbonate, iron oxide and alumina components, produced by the method as described herein.

In one aspect there is provided use of a desert sand of a type that also comprises calcium carbonate, iron oxide and alumina components for the production of a cement raw material feedstock, wherein, prior to producing the cement raw material feedstock, the amount of silica in the desert sand is reduced according to the method as described herein.

The applicant has identified desert sands as a potential new source of feed stock for cement production. However, to render desert sands as a suitable feed stock for cement production, the applicant has noted that prior art methods and processes, such as those set forth above, are not suitable for the required beneficiation of desert sand, and to enable a commercial scale of production.

The method as disclosed herein can comprise imparting a net negative electrical charge to a silica component and a net positive electrical charge to a calcium carbonate component of the desert sand through interparticle friction by a triboelectrostatic mechanism.

Due to the afore-mentioned coating with iron oxide and clays of the calcium carbonate, silica and other minerals in desert sands, the triboelectrostatic mechanism that imparts the charge to the silica and calcium carbonate components may be operated in a manner whereby such components are liberated from such coatings. This liberation from the coatings may occur during the charging step/stage (e.g. during conveying of the desert sands through a triboelectrostatic separator) and/or it may occur during in a pre-treatment (e.g. particle treatment) step/stage. Liberation may comprise breaking-up of agglomerated particles and/or fracturing of iron oxide or clay coatings, exposing uncoated particle surfaces and increasing the free surface area of the particles.

The method can also comprise applying an electric field to the charged components of the desert sand by a triboelectrostatic mechanism. As a result, the negatively charged silica component can be separated from a remainder of the components of the desert sand to thereby produce the cement raw material feedstock.

By application of the electric field to the electrically charged components of the desert sand, the electrically charged components undergo electrostatic forces, causing the charged components to stratify in relation to the applied field (i.e. to become fractionated), based on their net electrical charge. In contrast, components of the desert sand which remain substantially uncharged, or which retain a relatively small electrical charge (i.e. electrically neutral components), will be unaffected by application of the electric field. The use of electrostatic forces provides a ‘dry’ separation technique, whereby addition of water to substantially dry particulate mixtures is not required.

For ease of reference, these and further aspects of the present invention are now discussed under appropriate section headings. However, the teachings under each section are not necessarily limited to each particular section.

### Desert Sand

The desert sand contemplated by the present disclosure comprises multiple desirable components for cement raw material feedstock production, including calcium carbonate, iron oxide and alumina components. As set forth above, such desert sands are not amenable to conventional electrostatic separation techniques commonly employed to reduce the silica content of limesands for example, because the presence of the additional desirable components in desert sands (e.g. iron oxide and alumina) necessitate particular triboelectrostatic processing, in order effectively reduce the silica content of these sands.

As also set forth above, such desert sands have a different composition to e.g. limesands and the like due to the inclusion therein of iron oxide and alumina components.

Herein, the term “desert sand” refers to . . . [define by CaCO₃ and SiO₂ content? Typically comprising over 90% by weight of desert sands.]

As will be appreciated by one skilled in the art, desert sands are typically created by desertification and arid climatic conditions, such as those classified as Köppen BWh, over thousands to millions of years by the erosion of rocks. As they break up into finely divided particles and transported by air, they cause further abrasion and weathering of rocks. Finer and lighter particles of clay and organic matter are blown away leaving behind limestone (calcium carbonate), silica and other trace minerals. Areas along desert coastlines have high concentrations of calcium carbonate due to the fossilisation of marine organisms. Sand particles are rounded in shape due to inter-particle abrasion rendering them useless for construction which requires high particle angularity to achieve interlocking within the concrete matrix. Apart from calcium carbonate and silica, desert sands contain minerals useful in the feedstock of cement raw material such as alumina (Al₂O₃), iron oxide (Fe₂O₃) and magnesium oxide (MgO). Desert sand deposits are often formed on the earth's surface in dune structures created by wind and gravity

It is also noted that the particle size and density differences employed in some prior art processes are not typically useful parameters to aid in the separation of components of desert sands, given the similar densities and particle size/morphology of the sand components.

Herein, the term “beneficiation” (or its variations) refers to the improvement of particulate mixtures by the separation of desirable components of the desert sand from less desirable components, in order to produce one or more streams of material having a greater proportion of the desirable components, and one or more streams of material having a greater proportion of the less desirable components.

Herein the term “liberate” (or its variations) embraces partial removal of the oxide and clay coatings of components of the desert sand and exposure of the silica and carbonate components to the extent that such components can then become charged (i.e. positively or negatively). In this regard, the components need not be ‘fully’ liberated from such coatings.

In some embodiments, the desert sand may be a naturally occurring desert sand, such as a sand typically occurring in arid deserts having a Köppen climate classification of BWh.

Such desert sands can be sourced from desert regions across the world. For example, the largest contiguous expanse of the world's deserts stretches from the Middle-east to Western Africa. Apart from this, sandy deserts are found on all inhabited continents. These vast volumes of sands have hitherto been considered unfavourable for use in construction materials, due to the mineral composition and particle shape/size of the sands being unviable as a fine aggregate in concrete. Minor quantities of sand are however used in cement production, but typically as a source of silica, as a corrective material in the raw meal.

Extensive areas of the world's deserts are situated along marine coastlines, the geological evolutions of which have created suitable desert sands. These sands can also contain useful quantities of alumina, iron oxide, magnesium oxide and trace elements for cement clinker raw material. Despite containing calcium carbonate, such desert sands have not been considered hitherto as an alternative to limestone for cement production. The high levels of silica, intimately homogenised with the carbonate, have precluded such consideration. However, it is observed that the method and system of the present disclosure is able to readdress this consideration.

In some embodiments, the desert sand may comprise iron oxide in an amount, by weight, greater than about 0.5%, greater than about 0.7%, or greater than about 1%. In some embodiments, the desert sand may comprise iron oxide in an amount, by weight, of from 0.5 to 10%, from 0.7 to 10%, or from 1 to 10%. In some embodiments, the desert sand may comprise iron oxide in an amount, by weight, of from 0.5 to 5%, from 0.7 to 5%, or from 1 to 5%. Desert sands having such compositions may be selected for beneficiation by the method disclosed herein.

In some embodiments, the desert sand may comprise alumina in an amount, by weight, greater than about 1%, greater than about 1.5%, or greater than about 2%. In some embodiments, the desert sand may comprise alumina in an amount, by weight, 1 to 10%, 1.5 to 10%, or 2 to 10%. In some embodiments, the desert sand may comprise alumina in an amount, by weight, 1 to 8%, 1.5 to 8%, or 2 to 8%. Again, desert sands having such compositions may be selected for beneficiation by the method disclosed herein.

A person of skill in the art will appreciate that desert sands of other compositions may be employed, but with attendant reduction in triboelectrostatic separation efficiency and subsequent cement production.

In some embodiments, the desert sand may comprise calcium carbonate in an amount, by weight, not greater than about 95%. In some embodiments, the desert sand may comprise calcium carbonate in an amount, by weight, not greater than about 90%. In some embodiments, the desert sand may comprise calcium carbonate in an amount, by weight, not greater than about 85%. In some embodiments, the desert sand may comprise calcium carbonate in an amount, by weight, not greater than about 80%. A person of skill in the art will readily appreciate that the application of triboelectric separation techniques to sands containing relatively high levels of calcium carbonate may be inefficient and/or unnecessary.

In some embodiments, the desert sand may comprise calcium carbonate in an amount, by weight, of approximately 50-95%. In some embodiments, the desert sand may comprise calcium carbonate in an amount, by weight, of approximately 50-90%. In some embodiments, the desert sand may comprise calcium carbonate in an amount, by weight, of approximately 50-85%. In some embodiments, the desert sand may comprise calcium carbonate in an amount, by weight, of approximately 60-95%. In some embodiments, the desert sand may comprise calcium carbonate in an amount, by weight, of approximately 60-90%. In some embodiments, the desert sand may comprise calcium carbonate in an amount, by weight, of approximately 60-85%. A person of skill in the art will readily appreciate that the application of triboelectric separation techniques to sands containing relatively low levels of calcium carbonate may be inefficient and/or uneconomic.

In some embodiments, the desert sand may comprise silicon oxide in an amount, by weight, of at least 2%. In some embodiments, the desert sand may comprise silicon oxide in an amount, by weight, of at least 5%. In some embodiments, the desert sand may comprise silicon oxide in an amount, by weight, of at least 10%.

In some embodiments, the desert sand may comprise silicon oxide in an amount, by weight, of approximately 2-30%. In some embodiments, the desert sand may comprise silicon oxide in an amount, by weight, of approximately 5-30%. In some embodiments, the desert sand may comprise silicon oxide in an amount, by weight, of approximately 10-30%. In some embodiments, the desert sand may comprise silicon oxide in an amount, by weight, of approximately 2-20%. In some embodiments, the desert sand may comprise silicon oxide in an amount, by weight, of approximately 5-20%. In some embodiments, the desert sand may comprise silicon oxide in an amount, by weight, of approximately 10-20%.

In some embodiments, the desert sand may comprise magnesium oxide in an amount, by weight, of no greater than 10%. In some embodiments, the desert sand may comprise magnesium oxide in an amount, by weight, of no greater than 5%. In some embodiments, the desert sand may comprise magnesium oxide in an amount, by weight, of no greater than 3%.

In some embodiments, the desert sand may comprise magnesium oxide in an amount, by weight, of approximately 0.5-10%. In some embodiments, the desert sand may comprise magnesium oxide in an amount, by weight, of approximately 1-10%. In some embodiments, the desert sand may comprise magnesium oxide in an amount, by weight, of approximately 0.5-5%. In some embodiments, the desert sand may comprise magnesium oxide in an amount, by weight, of approximately 1-5%. In some embodiments, the desert sand may comprise magnesium oxide in an amount, by weight, of approximately 0.5-3%. In some embodiments, the desert sand may comprise magnesium oxide in an amount, by weight, of approximately 1-3%.

In some embodiments, the desert sand may have a moisture content, by weight, of no greater than 10%. In some embodiments, the desert sand may have a moisture content, by weight, of no greater than 8%. In some embodiments, the desert sand may have a moisture content, by weight, of no greater than 6%. In some embodiments, the desert sand may have a moisture content, by weight, of no greater than 5%. In some embodiments, the desert sand may have a moisture content, by weight, of no greater than 4%. In some embodiments, the desert sand may have a moisture content, by weight, of no greater than 3%. In some embodiments, the desert sand may have a moisture content, by weight, of no greater than 2%. In some embodiments, the desert sand may have a moisture content, by weight, of no greater than 1%.

In some embodiments, the desert sand may have a moisture content, by weight, of 0.1-10%. In some embodiments, the desert sand may have a moisture content, by weight, of 0.1-8%. In some embodiments, the desert sand may have a moisture content, by weight, of 0.1-6%. In some embodiments, the desert sand may have a moisture content, by weight, of 0.1-5%. In some embodiments, the desert sand may have a moisture content, by weight, of 0.1-4%. In some embodiments, the desert sand may have a moisture content, by weight, of 0.1-3%. In some embodiments, the desert sand may have a moisture content, by weight, of 0.1-2%. In some embodiments, the desert sand may have a moisture content, by weight, of 0.1-1%.

In some embodiments, one or more parameters relating to the composition of the desert sand and/or the calcium-carbonate stream may be measured. The measurement of the one or more parameters may be used to determine a set of optimum parameters for the separation of the silica component from the remainder of the components of the desert sand. The set of optimum conditions may include triboelectrostatic separation conditions, such as material feed rate, feed port size and geometry, particle charging parameters, belt speed (in the case of belt-type separators), electrode gap distance, electrode polarity, applied electrode voltage, moisture levels, etc.

In some embodiments, the one or more parameters may relate to the silica content of the desert sand and/or the cement raw material feedstock. In this way, the composition of the beneficiated streams (including both carbonate-rich and silica-rich product streams) may be controlled to suit the requirements of the downstream process of cement manufacture. Further, monitoring of both output and feed stream compositions may inform optimisation of triboelectrostatic separation conditions, for example, by way of an on-line feedback arrangement. A person of skill in the art will appreciate that other useful parameters of the desert sand may be measured, including particle size for example.

In some embodiments, the one or more parameters may be measured by X-ray fluorescence or X-ray diffraction. In this regard an online feedback loop using X-ray fluorescence analysis may be employed to tune separator/separation parameters. This may provide excellent control of desired product composition and reduce downtime for both the triboelectrostatic separation process and downstream cement manufacturing process, where time-consuming adjustment to feedstocks of differing compositions may typically be required.

### Triboelectrostatic Separation

By imparting a net electrical charge of opposite polarity to the silica component and the calcium carbonate component, separation of the silica component may be effected under a number of different electric field configurations. For example, where the electric field is applied by means of positive and negative electrodes, positively charged components of the sand will be electrically attracted to a negative electrode and electrically repelled by a positive electrode.

In contrast, where the charged components of the desert sand are passed near an electrode or charged plate of only one polarity, those components of the desert sand having an electrical charge of the opposite polarity will be attracted toward the one electrode, while those of the opposite polarity will be repelled. In this way, the desert sand may be stratified based on the electrical charge imparted to components within the sand, and by using a number of different electric field configurations. In this regard, the degree of beneficiation (or reduction of silica in the beneficiated stream) may be stratified based on the proximity of the charged particles to the electrodes and/or the degree of electrical charge imparted to the particles. Very high levels of separation may be achieved at the extreme ends of a separator (i.e. nearest the electrodes) and excellent control of desired composition may result.

In some embodiments, and as set forth above, electrical charge may be imparted to components of the desert sand by passing the sand over a charged plate or substrate. In some other embodiments, electrical charge may be imparted by employing an a triboelectrostatic mixing operation, such as in a fluidized bed or cyclone apparatus.

In some embodiments, and as set forth above, the imparting of the electrical charge and the application of the electric field may occur concurrently in a conveying triboelectrostatic separation stage. In this regard, the conveying triboelectrostatic separation stage may serve to impart electrical charge to components of the desert sand, by causing interparticle friction between the sand particles. Such interparticle friction may also serve to liberate calcium carbonate and silica particles in the sand, by physical agitation of the sand particles.

In some embodiments, and as set forth above, the triboelectrostatic mechanism by which the electric field is applied to the charged components of the desert sand may comprise a positive electrode and a negative electrode. Use of both positive and negative electrodes may enhance the efficiency of the triboelectrostatic separation, as compared to employing an electrode of a single electrical polarity and an earth electrode, for example. By employing both positive and negative electrodes, silica may be more effectively separated from desert sands also containing a range of other mineral constituents, including iron oxides, alumina, clays, etc.

In some embodiments, the conveying triboelectrostatic separation stage comprises a belt-type triboelectrostatic separation stage.

In some embodiments, the triboelectrostatic separation stage may comprise a plurality of triboelectrostatic separation stages. Multiple triboelectrostatic stages may be employed where a particularly well separated (highly beneficiated) product is required. It will be readily appreciated by a person of skill in the art that beneficiated streams may also be recirculated through one or more triboelectrostatic separation stages, to further beneficiate the stream.

In some embodiments, the plurality of triboelectrostatic separation stages may be arranged in series or in parallel. A ‘series’ arrangement may provide higher degrees of beneficiation of the stream, whilst a ‘parallel’ arrangement may provide for increased material throughput. A combination of series and parallel arrangements may be employed.

In other embodiments, the triboelectrostatic separation stage/s may occur in one or more of a free-fall or drum-type triboelectrostatic separator. In this regard, and as set forth above, where a free-fall or a drum-type separator is employed, it may be necessary to impart additional electrical charge to components of the desert sand in order to achieve separation of the silica component from the remainder of the components of the desert sand and to thus produce the cement raw material feedstock. Such additional electrical charge may be imparted by employing a pre-charging stage, for example by passing the desert sand to a fluidized bed reactor, a cyclone apparatus or another apparatus for generating interparticle friction within the desert sand.

In contrast to such free-fall and drum electrostatic separators, a conveying (e.g. belt conveying) triboelectrostatic method applied to the beneficiating of desert sands differ from free-fall and drum electrostatic separators in fundamental aspects: horizontal rather than vertical electrodes and separation zone, simultaneous multi-stage charging and conveying of material by a high-speed open mesh conveyor belt, effective separation of particle sizes under 75 microns, relatively low voltage (±6 and ±10 kV) used due to narrow electrode gap, and no requirement for high temperature thermal pre-treatment.

In some embodiments of the method, the voltage applied to produce the electric field may not exceed 50 kV. In some embodiments of the method, the voltage applied to produce the electric field may not exceed 30 kV. In some embodiments of the method, the voltage applied to produce the electric field may not exceed 20 kV. In some embodiments of the method, the voltage applied to produce the electric field may not exceed 10 kV. In some embodiments of the method, the voltage applied to produce the electric field may not exceed 8 kV. This can especially be the case with a conveying (e.g. belt conveying) triboelectrostatic method.

In some embodiments of the method, the voltage applied to produce the electric field may be from 3 to 50 kV. In some embodiments of the method, the voltage applied to produce the electric field may be from 3 to 30 kV. In some embodiments of the method, the voltage applied to produce the electric field may be from 3 to 20 kV. In some embodiments of the method, the voltage applied to produce the electric field may be from 3 to 10 kV. In some embodiments of the method, the voltage applied to produce the electric field may be from 3 to 8 k V.

In some embodiments of the method, the voltage applied to produce the electric field may be from 5 to 50 kV. In some embodiments of the method, the voltage applied to produce the electric field may be from 5 to 30 kV. In some embodiments of the method, the voltage applied to produce the electric field may be from 5 to 20 kV. In some embodiments of the method, the voltage applied to produce the electric field may be from 5 to 10 kV. In some embodiments of the method, the voltage applied to produce the electric field may be from 5 to 8 kV.

In some embodiments, the method may further comprise a comminution step. Comminution of the raw sand particles, in the form of crushing and/or grinding, may improve particle liberation of the contained CaCO₃ and SiO₂ minerals in the sand, improving triboelectrostatic separation efficiency. Grinding of the sand (or of the beneficiated product) can also serve to reduce particle size, which may be advantageous for downstream cement manufacturing processes, where feed material for raw cement meal having particle sizes below 100 microns may be preferred. However, such a comminution step may be considerably reduced in scale, complexity and cost compared to that employed for conventional cement production. This is because sand (e.g. desert sand) is already considerably reduced in particle size compared to quarried limestone.

In some embodiments, the comminution step may be carried out prior to reducing the amount of silica in the desert sand. In cases where the raw sand is of a desirable particle size and can be charged effectively within a triboelectrostatic separation stage, sand comminution may be omitted entirely.

In some embodiments, as set forth above, additional electrical charge may be imparted by passing the desert sand to a fluidized bed reactor, a cyclone apparatus or another apparatus for generating interparticle friction within the desert sand. In each case, electrical charge may be imparted to the particles of the sand by inter-particle friction and/or contact with surfaces of the particle charging apparatus. Fluidization of the particles of the desert sand (for example by application of a gas, such as air, in a fluidized bed reactor) may serve to both effectively impart electrical charge to the components of the sand by friction, whilst also improving the efficiency of the triboelectrostatic separation process. Well-fluidized particles may flow more easily through the process than less dynamic, unfluidized or packed particles. In particular, the relatively fine and uniform particle size of some desert sands may be particularly amenable to fluidization, potentially without the need for additional comminution steps.

In some embodiments, a cement raw material feedstock comprising calcium carbonate, iron oxide and alumina components may be produced by the method as set forth in the present disclosure.

In some embodiments, prior to producing the cement, the amount of silica in the desert sand may be reduced according to the method set forth above.

In a further aspect, there is disclosed the use of a desert sand of a type that also comprises calcium carbonate, iron oxide and alumina components for the production of a cement raw material feedstock. Prior to producing the cement raw material feedstock, the amount of silica in the desert sand may be reduced according to the method as set forth above.

In a still further aspect, there is disclosed a system for reducing the amount of silica in a desert sand of a type that also comprises calcium carbonate, iron oxide and alumina components, to thereby produce a cement raw material feedstock. The system comprises apparatus for imparting a net negative electrical charge to a silica component and a net positive electrical charge to a calcium carbonate component of the desert sand through interparticle friction.

As set forth above, the apparatus may be configured to liberate the calcium carbonate, silica and other minerals in desert sands from their coatings with oxides and clays. This liberation from the coatings may be imparted by the charging apparatus itself (e.g. by a conveyor, such as a belt-type conveyor) whereby the liberation from such coatings occurs during charging, and/or the liberation from such coatings may occur during in a pre-treatment (e.g. particle treatment) step/stage.

The system also comprises apparatus for applying an electric field to the charged components of the desert sand, such that the negatively charged silica component may be separated from a remainder of the components of the desert sand to thereby produce the cement raw material feedstock.

Both apparatus for imparting an electrical charge and for applying an electric field may be as set forth above.

In this regard, in some embodiments of the system, the imparting of the electrical charge and the application of the electric field may occur concurrently in a conveying triboelectrostatic separation stage. In other words, the same triboelectrostatic conveying apparatus may both charge and separate the silica from other components of the desert sand.

In some embodiments of the system, the conveying triboelectrostatic separation stage comprises a belt-type triboelectrostatic separation stage/separator.

In some embodiments of the system, the imparting of the electrical charge and the application of the electric field may occur in one or more triboelectrostatic separation stage(s)/separator(s).

In a further aspect, there is disclosed a system for the production of a cement raw material feedstock, the system comprising use of a desert sand of a type that also comprises calcium carbonate, iron oxide and alumina, as a primary feedstock.

### BRIEF DESCRIPTION OF THE DRAWINGS

Embodiments will now be described, by way of example only, with reference to the accompanying drawings in which:

FIG. 1 shows an embodiment of a belt type triboelectrostatic separator;

FIG. 2 shows an embodiment of a free-fall type triboelectrostatic separator, which may be employed only where sufficient additional electrical charge is imparted to the desert sand components;

FIG. 3 shows a process flow diagram for an embodiment of a method for the beneficiation of calcium-carbonate bearing sand;

FIG. 4 shows a process schematic for an embodiment of a method for the production of beneficiation of calcium-carbonate bearing feedstock;

FIG. 5 shows a process schematic for a further embodiment of a method for the production of beneficiation of calcium-carbonate bearing feedstock;

FIG. 6 shows experimental results for mineralogy studies of calcium-carbonate bearing sands; and

FIG. 7 shows a further embodiment of a belt-type triboelectrostatic separator, used in accordance with the present disclosure.

### DETAILED DESCRIPTION

In the following detailed description, reference is made to accompanying drawings which form a part of the detailed description. The illustrative embodiments described in the detailed description, depicted in the drawings and defined in the claims, are not intended to be limiting. Other embodiments may be utilised and other changes may be made without departing from the spirit or scope of the subject matter presented. It will be readily understood that the aspects of the present disclosure, as generally described herein and illustrated in the drawings can be arranged, substituted, combined, separated and designed in a wide variety of different configurations, all of which are contemplated in this disclosure.

Disclosed herein is a method and system for reducing the amount of silica in a desert sand of a type that also comprises calcium carbonate, iron oxide and alumina components. The desert sands, once suitably beneficiated by the method disclosed herein, may be used as cement raw material feedstock (i.e. as the major feed material for cement clinker raw meal), replacing the traditional mix of quarried limestone and separately added alumina, iron oxide and magnesium oxide. With suitably reduced silica content and inherently containing other beneficial minerals (particularly iron oxide, alumina and magnesium oxide), the beneficiated desert sand may provide a more efficient feedstock for cement production as compared with traditional sources of limestone or calcium carbonate.

Throughout this specification, all references to sand or desert sand should be taken to mean a naturally occurring, CaCO₃, Fe₂O₃ and Al₂O₃-bearing desert sand typically from regions with Köppen climate classification BWh.

An exemplary beneficiation process according to the present disclosure includes first assessing a candidate sand (such as a natural desert and/or coastal desert sand) for suitability as a cement raw material. This assessment includes mineralogy analysis, to ensure that the sand will be suitable as a raw feed for cement production. A typical exemplary composition for a raw meal used in cement clinker production is CaO 42-43 wt. % (equivalent to 75-77 wt. % CaCO₃), SiO₂ 13-14 wt. %, Al₂O₃ 3.5-4 wt. %, Fe₂O₃ 2-2.5 wt. % and MgO 1-2 wt. %, plus trace elements inherent in the raw materials.

It has been significantly and surprisingly discovered, that some naturally occurring desert sands exhibit a high degree of mineralogical similarity to common feed stocks for cement production. Specifically, some desert sands contain relatively high levels of calcium carbonate (CaCO₃, or limestone), along with useful quantities of alumina (Al₂O₃), iron oxide (Fe₂O₃), magnesium oxide (MgO) and other trace minerals for cement production. This is in contrast to traditional ‘limesands’ used as a source of calcium carbonate, which are lacking in many of the required minerals for cement raw clinker production, including Fe₂O₃ and Al₂O₃ for example.

The key deterrence to utilising such desert sands has been the high levels of silica comingled in the homogenised material. The presence of other minerals, in addition to the predominant calcium carbonate and silica (such as alumina and iron oxide, which are desirable in cement production) can also preclude such desert sands from being a viable feedstock in existing electrostatic separation processes, such as those directed to the beneficiation of limesands and quarried limestone.

With CaCO₃ and SiO₂ typically comprising over 90% by weight of desert sands, extraction of the SiO₂ results in a desirable concentration of CaCO₃, whilst also retaining the beneficial Al₂O₃ and Fe₂O₃. The resulting material can be utilised as a raw material suitable for the cement clinker raw meal production. As small amounts of silica (in the form of sand) are typically added in conventional raw clinker meal preparation process, it is not essential to completely eliminate/separate SiO₂ in the beneficiation process.

### Triboelectrostatic Separation

Triboelectric charge is an electrical charge generated by surface friction between dissimilar bodies or particles, commonly known as static electricity. In this phenomenon, electrons flow between the charged objects to balance the charge difference. The net electric charge imparted to a material can also be affected by the magnetic properties of the material.

All materials exhibit some form of magnetism, the two most common of which are paramagnetism and diamagnetism. In paramagnetic materials, atoms have randomly oriented magnetic moments with positive susceptibility. In diamagnetic materials, atoms have no magnetic moment and the susceptibility is negative. SiO₂ is the only diamagnetic mineral found to occur in significant quantities in typical desert sand compositions, while CaCO₃ is a paramagnetic material. It has been found that tribo-electrostatically charged SiO₂ exhibits a strongly negative electrical charge while tribo-electrostatically charged CaCO₃ exhibits a modestly positive electrical charge.

The opposite polarity net charge imparted to SiO₂ and CaCO₃ particles during triboelectrical charging can therefore be harnessed to substantially separate these components in desert sands and, in particular, to beneficiate the CaCO₃ component of the sands.

Liberation of the CaCO₃ and SiO₂ mineral particles in the sands (for example, by removal of surface oxides and other coatings from the individual particles) may be necessary for efficient separation in the triboelectrostatic process. Such liberation can be achieved by grinding or comminution of the sands, which also serves to reduce particle size. Grinding breaks through particle surface coatings and increases the surface area of the particles, which aids in triboelectrostatic charging. As raw meal typically requires grinding to below 100 micron particle size for effective sintering in a rotary kiln, the sand grinding process can be well integrated in a standard cement production process. However, such grinding of the sands represents a small fraction of that required for traditional quarried limestone.

There are three main types of triboelectrostatic separators: Free-fall separators, belt separators and drum separators. Due to deficiencies in prior art separation techniques, including that of free-fall and drum separators, scalability potential and the small particle size required for the raw meal, in the present disclosure the belt separator was initially selected for initial assessment of desert sands for triboelectrostatic separation. Particularly, it was observed that large belt type separators may offer increased material throughput and greater ability to customise separation parameters and enable large scale production viably.

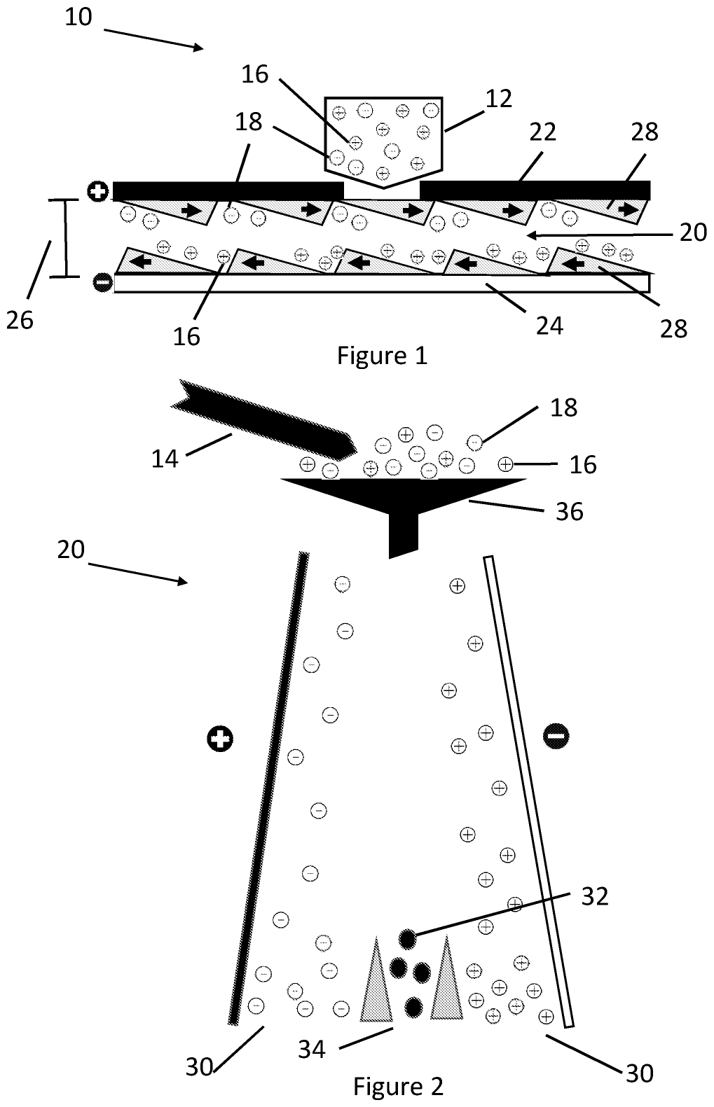

Referring to FIG. 1, which illustrates a belt-type triboelectrostatic separator 10, the general principle of triboelectrostatic separation is to charge a finely divided feed material 12 (e.g. sand) through vigorous friction. Unlike free-fall and drum separators, the particles are charged by the triboelectric effect through particle-to-particle collisions, as they are conveyed on the belt within the gap between the electrodes. This is achieved by a high-speed continuous loop, open mesh belt. This imparts the net positive 16 and negative 18 charge to the feed particles, according to their magnetic susceptibility. For carbonate-bearing desert sands, the CaCO₃ particles 16 attain a modest positive electrical charge, while the SiO₂ particles 18 attain a strongly negative electrical charge.

The tribo-electrostatically charged particles are passed through a horizontal separation zone 20 between electrically charged positive 22 and negative 24 electrodes, which define an electrode gap 26, between which an electric field is generated. The charged particles undergo vigorous agitation as they pass through the separation zone 20.

The positively charged particles 16 move towards the negative electrode 24 under the electrostatic force experienced by the particles in the electrical field, and the negatively charged particles move towards the positive electrode 22. The electrostatically separated particles 16, 18 are conveyed to respective ends of the triboelectrostatic separator 10 by conveying belts 28 located adjacent to the positive 22 and negative 24 electrodes, moving in opposite directions to one-another. Thus, separated fractions may be collected in hoppers located at either end of the belt separator 10 or the separated streams may be processed in a second stage or conveyed directly to a downstream cement making process.

The properties of the feed material (e.g. suitable desert sands evaluated by X-ray diffraction, liberation testing and particle size measurement) will determine the optimum triboelectrostatic parameters for a given separator. For example, the efficiency of the triboelectrostatic process may be improved by fine tuning a range of separator parameters, including material feed rate, feed port size and geometry, particle charging parameters, belt speed (in the case of belt-type separators), electrode gap distance, electrode polarity, applied electrode voltage, etc. Use of bench-scale and pilot-scale separators as described herein can be used to determine optimal, energy-efficient parameters for commercial scale triboelectrostatic separators.

Referring to FIG. 2, in the case of a free-fall triboelectrostatic separator 20, additional electrostatic charge must be imparted to the desert sand particles to provide for effective separation of the silica from the remainder of the components of the desert sand. This is because of the presence of minerals including iron oxide and alumina in the desert sand, which can act to reduce the electric charge imparted to the calcium carbonate and silica particles. A free-fall triboelectrostatic separator 20 has been found to not provide sufficient inter-particle tribolectrostatic charging, as can be achieved in a conveying belt-type separator. In order for a free-fall triboelectrostatic separator to be successfully deployed with desert sands comprising iron oxide and alumina, a particle charger 14, such as a cyclone-type or fluidized bed charger must be employed.

Triboelectrostatically charged particles 16, 18 are then poured, by an air slide feeder 36 for example, between two charged electrodes in the form of plates (positive 22 and negative 24 electrodes). These plates laterally draw falling particles of the opposite charge towards them (repelling like charged particles), with collection occurring at respective base portions 30 located adjacent to the electrodes 22, 24, while poorly charged or electrically neutral particles 32 fall to the centre 34 of the separator base (with such particles classified as “middlings”). Poorly charged particles may be disposed of or recirculated through the separator stage, for additional particle charging and further separation. As for belt-type separators, the particles in the feed material (or recirculated middlings) may receive additional triboelectrostatic charge in a particle charger 14, such as a cyclone-type or fluidized bed charger. Alternate configurations of the free-fall separator 20 are possible. For example, an alternative free-fall triboelectrostatic separator may comprise two side-wall electrodes of one electrical polarity, with one or more electrodes of opposite polarity arranged near the middle or core of the separator.

Both belt 10 and free-fall 20 separators operate on similar triboelectrostatic separation principles, but may differ significantly in effectiveness, depending upon particle size and level of mineral liberation. While belt separators 10 are more suited to materials of small particle size (such as desert sands) and high material throughput, free-fall separators 20 tend to produce higher material purity at the extreme ends of collection, close to the electrodes (i.e. at the respective base portions 30 of FIG. 2) and may be used as an initial step or initial separation stage to reduce the SiO₂ concentration in the feed material before subsequent processing in a belt separator (i.e. in a multi-stage separation process). As noted above however, sufficient pre-charging of the desert sand particles must be undertaken, if a free-fall type separator is to be successfully employed.

A person of skill in the art will appreciate that, in each application, multiple separator geometries and arrangements are possible, including for example multiple positive and negative electrodes arranged in various configurations (series, parallel, recycle modes, etc.).

Carefully controlled variations to separator settings including feed rate, feed port geometry, belt speed, electrode gap, electrode polarity, and applied voltage can improve the separation capability and efficiency in reducing silica and concentrating the carbonate component of candidate desert sand feedstock. As with other mining ores, variations in concentrations of carbonate, silica and trace elements are expected between sands from different geographic locations. A pilot process simulating commercial production can be employed to determine a range of optimal separator settings, which may be applied to commercial-scale triboelectrostatic separators.

### Generalised Separation Process

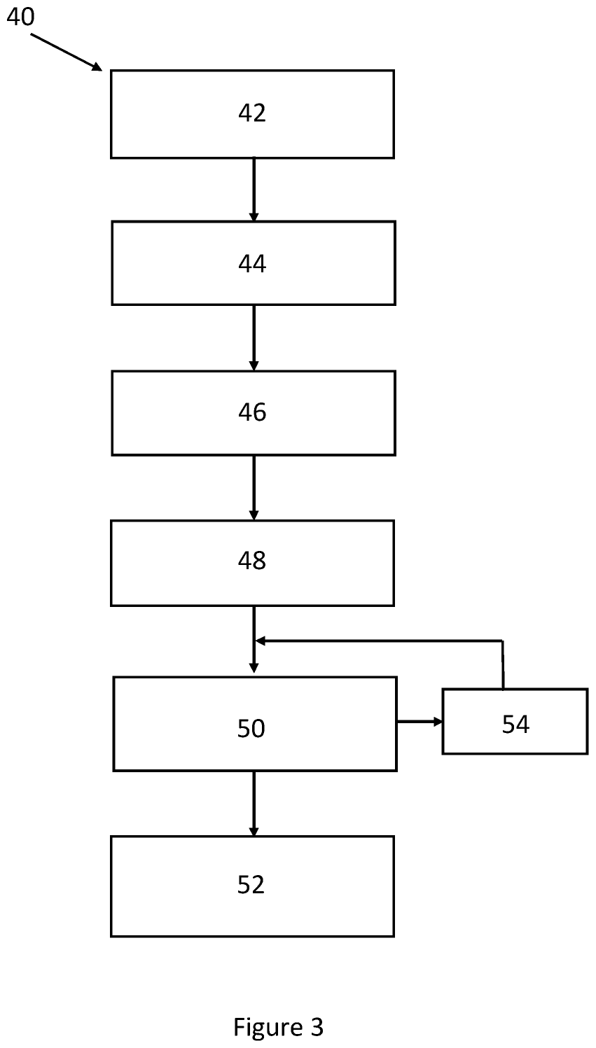

Referring to FIG. 3, an exemplary beneficiation flow diagram 40 according to the present disclosure includes the step 42 of assessing a candidate desert sand for suitability as a cement raw material, to be beneficiated according to the present disclosure. Such assessment includes a mineralogy analysis of the sand, which can be performed by X-ray techniques, including X-ray fluorescence (XRF) and/or X-ray diffraction (XRD), however those skilled in the art will appreciate that a multitude of analytical techniques may be used to determine the qualitative (and quantitative) mineralogy of potentially suitable materials. Sands having CaCO₃ contents of over 65% by weight are preferred for efficiency reasons, but sands of lower carbonate content can also be beneficiated according to the triboelectrostatic separation processes described herein. For example, sands having CaCO₃ contents of approximately 50-85%, may be suitable. Candidate sands are also analysed to ensure that any deleterious minerals, particularly sulphates and chlorides, are below the levels of prescribed standards for relevant cement type production.

Following sand selection 42, a pilot triboelectrostatic separator 44 can be employed to determine optimal operation parameters, prior to up-scaling for commercial separation. A quantity of 2-3 tonnes of selected desert sand is run through a pilot triboelectrostatic separator, as described above with reference to FIGS. 1 and 2. In the case of a belt separator; feed rate, feed port, belt speed, electrode gap, electrode polarity, and applied voltage are optimised to maximise the separation (i.e. rejection) of SiO₂ and an increase in the concentration of CaCO₃ in the separated material. In the case where a free-fall separator is determined to be suitable for a given sand composition and/or morphology, the scale of the separator, feed rate, electrode position, electrode applied voltage and trajectory of fall of charged particles can be adjusted to optimise the collection location and concentration of the carbonate-rich product collected at the base of the separator.

With suitable feed material and triboelectrostatic parameters determined, dry delivery and screening of large quantities of feedstock sand can begin 46. The triboelectrostatic process is dependent on finely divided, dry material processed at low relative humidity in order to impart the electrostatic charge and effect the separation at optimal separator settings. Desert sands with viable concentrations of CaCO₃, Al₂O₃ and Fe₂O₃, but containing significant amounts of dust (as determined for example in particle size distribution testing) may be dedusted using a commercial classifier for example, as widely used in the construction materials industry. It should be noted that, given the requirement for low-moisture feedstock for effective charging of the particles, wet de-dusting operations (typical in limestone quarrying) are not employed. Dedusting improves the efficiency of the triboelectrostatic separation process, by preventing dust build-up on electrodes and thus increasing the electrode efficiency. The sand can also be sieved at the delivery point to remove any large particles, providing a sand for triboelectrostatic separation typically having a maximum particle size range of 500-1000 microns. Comminution of the sand particles may further reduce the particle size, with belt-type triboelectrostatic separators able to process particle sizes less than 75 microns and even down to 50, 10 or 1 micron.

An optional sand milling/grinding or comminution step 48 may be carried out, particularly when CaCO₃ and SiO₂ particles are not well liberated within the raw sand. Such milling can be carried out by any one or more of the grinding and crushing methods known in the art. Where the minerals are well liberated in the raw sand, this step may not be required. Particle size reduction can however be required to increase mineral liberation for effective triboelectrostatic separation, where some of the grinding mills commonly used in cement plants may be employed to reduce particle size to 50-60 microns for example (or to finer particle sizes, as determined by sand analysis). In conventional cement production processes, pre-homogenised material is ground to <100 microns in the raw meal homogenisation process, thus the milling step for mineral liberation of desert sand feedstock can be well integrated with the normal processes of a conventional cement plant. However, only a fraction of the plant and energy requirements for such milling can be required for sand.

Commercial scale triboelectrostatic separation 50 can then take place, using customised variants of free-fall 20 or belt 10 separators suited to the composition of the selected sand and the required beneficiated material volume of mid to large size cement plants. To accommodate high-volume demand for CaCO₃ beneficiated feedstock, large-scale separators or multiple smaller separators in series or parallel may be employed, before the beneficiated product is passed to a downstream cement-making process 52.

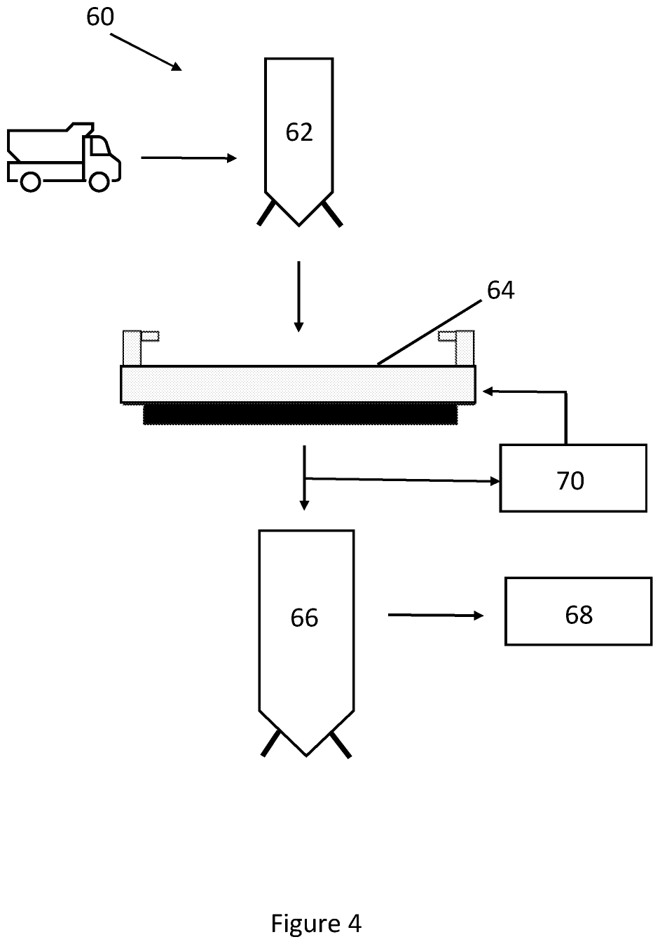

In one form of the process where the CaCO₃ and SiO₂ minerals within the raw, desert sand are well liberated (and thus capable of efficiently retaining electric charge in the particle charging process), a belt separator may be used directly after the separator settings have been optimised in the pilot program 44. This process is illustrated in FIG. 4. In this direct process 60, the raw sand 62 is passed directly to a triboelectrostatic separation stage (illustrated as a belt-type separator 64), after which the concentrated or enriched carbonate fraction is then passed to a storage silo 66 as feedstock for the raw meal homogenisation stage 68 required in the cement-making process.

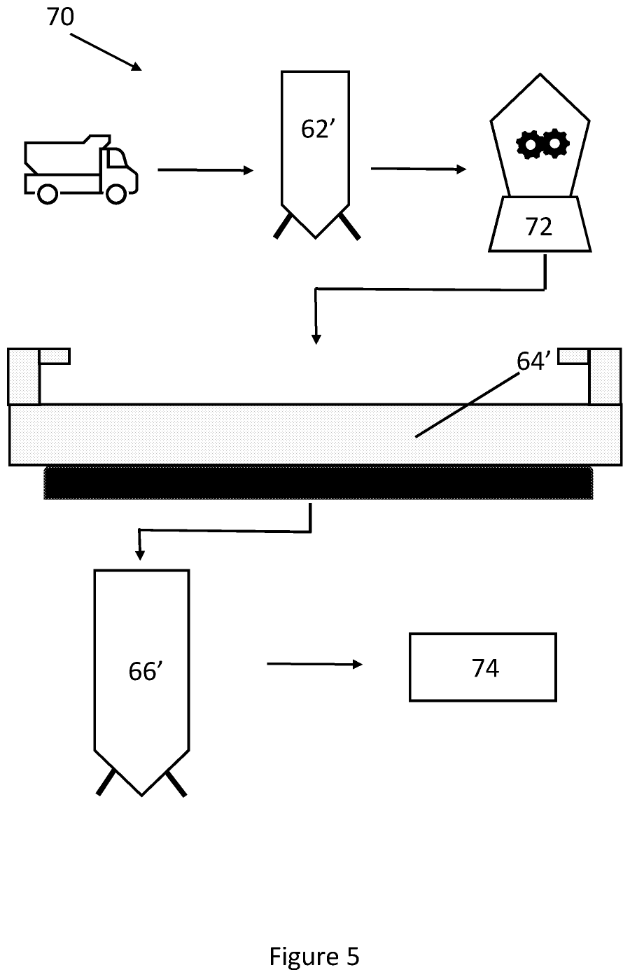

In other forms of the process where the CaCO₃ and SiO₂ minerals are poorly liberated in the raw sand 70 (as illustrated in FIG. 5), grinding by some of the mills 72 used in conventional cement plants, to achieve particle sizes of 50-60 microns, liberates the minerals by increasing particle surface area and enhancing the particles capability to retain the triboelectrostatic charge. The material is then processed through an optimised belt separator 64′ and the carbonate-rich fraction also containing alumina and iron oxide is conveyed to silo 66′ as feedstock for further processing 74. The free-fall type separator may not be viable in this case, as it is generally suited to larger particle sizes.

As current triboelectrostatic belt, free-fall or drum separators have not been designed specifically for the separation of carbonates from silica in desert sand, for use by the cement industry, it is foreseen that customised plant and machinery based on known triboelectrostatic principles will be developed, which are better suited to the sand feed materials available. Improvements to belt separators, such as vibratory feed hoppers, cyclones, fluidised beds or other pre-charging add-on equipment, differential electrode positive and negative charging and other incremental improvements and extensions are within the ambit of this disclosure.

### EXAMPLES

Non-limiting Examples will now be described.

### Belt Triboelectrostatic Beneficiation Studies

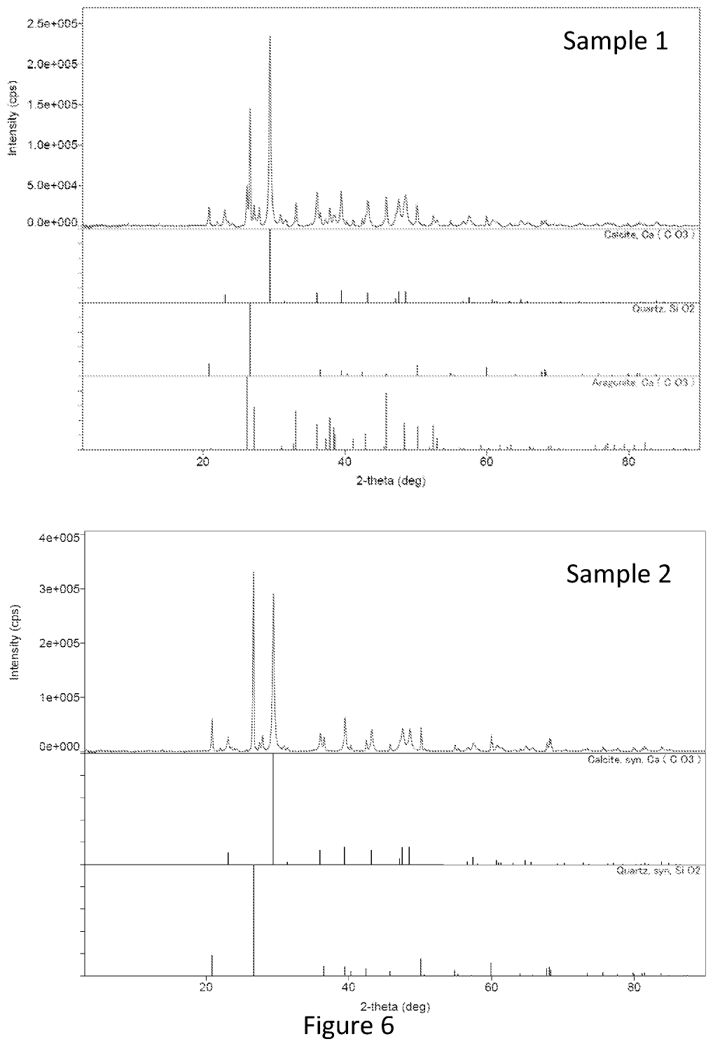

Two samples of potentially suitable costal desert sands, designated Sample 1 and Sample 2, were initially evaluated by X-Ray Diffraction to determine primary minerology (see FIG. 6) followed by Wavelength Dispersive XRF (PANalytical Zetium), to determine indicative amounts (as a percentage of standard oxides) of the key components necessary in raw meal for cement production, as given in Table 1.

TABLE 1

| Sample | CaO/% | SiO2/% | Fe2O3/% | Al2O3/% | MgO/% | K2O/% | LOI/% |
|---|---|---|---|---|---|---|---|
| 1 | 39.2 | 19.8 | 0.6 | 2.7 | 1.8 | 0.3 | 33.4 |
| 2 | 33.8 | 30.9 | 1.1 | 3.0 | 1.6 | 0.6 | 27.6 |

A typically desirable composition for a raw meal used in cement production is CaO 42-43 wt. % (equivalent to 75-77 wt. % CaCO₃), SiO₂ 13-14 wt. %, Al₂O₃ 3.5-4 wt. %, Fe₂O₃ 2-2.5 wt. % and MgO 1-2 wt. %, plus trace elements inherent in the raw materials. Each of sand samples 1 and 2 were found to be broadly suitable for use in cement production. Sand samples 1 and 2 were also considered as good candidates for beneficiation by the belt triboelectrostatic technique.

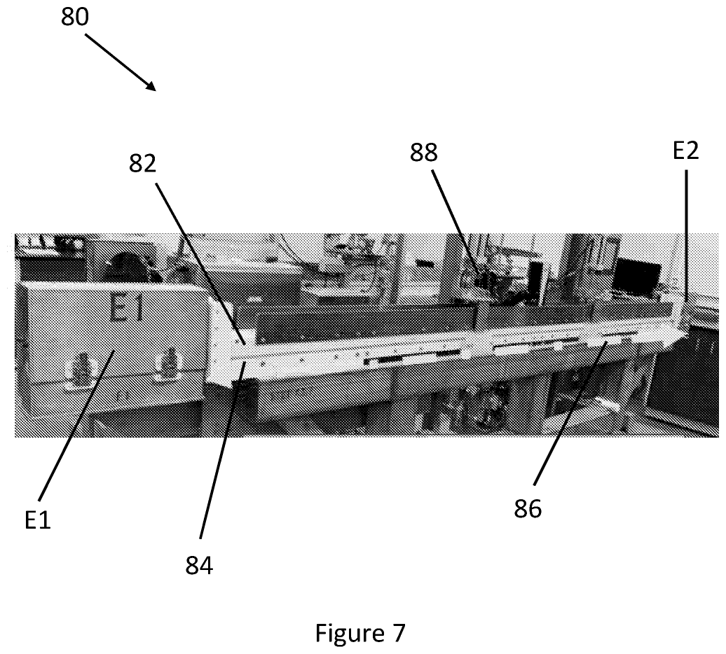

Triboelectrostatic separation of sand samples 1 and 2 was carried out using a bench-scale triboelectrostatic separator (X3.7 Separator 80, see FIG. 7) supplied by ST Equipment & Technology, USA to assess the effectiveness of particle charging and electrostatic separation of calcium carbonate and silica particles contained in the sands. The bench-scale triboelectrostatic separator was of a belt-type, having top electrode 82 and bottom electrode 84 dimensions of 5 cm width by 365 cm length 86, with an agitation-type particle charger 88. Separated particles were conveyed to one of two material output ends (E1 and E2), based on their electrical charge. It will be understood by a person of skill in the art that the electrical polarity of each electrode in a bench-scale separator may be readily changed, to optimise separation efficiency for particular feed stocks.

Each of Sample 1 and Sample 2 consisted of 20 kg of dry, finely divided sand comprising carbonate (CaCO₃), silica (SiO₂) and other trace constituents. The samples were initially dry-sieved to remove minor organic debris, followed by milling (comminution) of a portion of each sample to produced milled and un-milled variants. Milling was performed using a lab-scale Hosokawa hammer mill (Hosokawa Micron Powder Systems, USA), with particle size distributions for milled and un-milled samples given in Tables 2 and 3 respectively, measured using a Malvern Instruments Mastersizer 3000E, with a dry powder dispersion unit. The moisture content of the as-received (un-milled) samples was determined using a drying oven at 110° C. (Table 2).

TABLE 2
Unmilled Samples

| | | Particle Size Distribution | | | |
|---|---|---|---|---|---|
| | Moisture/ % | Dx 10/ μm | Dx 50/ μm | Dx 90/ μm | Dx 98/ μm |
| Sample | | | | | |
| 1 | 0.6 | 105 | 331 | 744 | 960 |
| 2 | 0.4 | 105 | 199 | 396 | 567 |
| Mean | | 105 | 265 | 570 | 763 |
| 1 × Std Dev | | 0.533 | 93.6 | 246 | 278 |
| 1 × RSD/ % | | 0.508 | 35.3 | 43.2 | 36.4 |

TABLE 3
Milled Samples

Particle Size Distribution

| | Dx 10/ | Dx 50/ | Dx 90/ | Dx 98/ |
|---|---|---|---|---|
| | μm | μm | μm | μm |
| Sample | | | | |
| 1 | 11.5 | 59.6 | 169 | 287 |
| 2 | 8.18 | 50.9 | 141 | 237 |
| Mean | 9.85 | 55.2 | 155 | 262 |
| 1 × Std Dev | 2.36 | 6.14 | 19.9 | 35.4 |
| 1 × RSD / %0a | 23.9 | 11.1 | 12.9 | 13.5 |

Milled and unmilled variants of Samples 1 and 2 were passed through the bench-scale triboelectrostatic separator in 1.5 kg feed batches, with separated output material passed to one of two product ends, designated End 1 (E1) and End 2 (E2).

Each of the milled and un-milled samples, and the output products of the triboelectrostatic separator (E1 and E2) were analysed by Wavelength Dispersive XRF (PANalytical Zetium) to determine indicative chemical compositions as a percentage of standard oxides, as given in Table 4. To prepare the samples for XRF analysis, the samples were heated to 1000° C. for 1 hr. Such heating results in calcination of the calcium carbonate present in the sample, to produce calcium oxide (lime) and carbon dioxide, with attendant loss-on-ignition (LOI) weight reduction, according to the following reaction:

$${CaCO}_{3} \to CaO + {CO}_{2}$$

Thus, the XRF technique directly measured the presence of CaO in the sample, which was used to determine the CaCO₃ content present in the sample, prior to heating.

Table 4 details indicative compositions (wt. %) of the feed samples and the output of triboelectric separation, as determined by Wavelength Dispersive XRF.

TABLE 4

| | Unmilled Sand | | Milled Sand | |
|---|---|---|---|---|
| | SAMPLE 1 | SAMPLE 2 | SAMPLE 1 | SAMPLE 2 |
| Feed Wt./ lb | 1.50 | 1.50 | 1.50 | 1.50 |
| End 1 Wt./ lb | 1.25 | 1.04 | 0.42 | 0.60 |
| End 2 Wt./ lb | 0.14 | 0.29 | 0.81 | 0.75 |
| Yield End 1/ % | 89.9 | 78.2 | 34.1 | 44.4 |
| Yield End 2/ % | 10.1 | 21.8 | 65.9 | 55.6 |
| Feed LOI/ % | 33.8 | 26.90 | 33.82 | 27.07 |
| E1 LOI/ % | 32.9 | 25.38 | 29.97 | 19.47 |
| E2 LOI/ % | 41.0 | 35.13 | 38.65 | 38.73 |
| Feed Al2O3/ % | 2.3 | 2.7 | 2.0 | 2.5 |
| E1 Al2O3/ % | 2.1 | 2.9 | 2.6 | 3.5 |
| E2 Al2O3/ % | 0.8 | 1.2 | 1.4 | 1.4 |
| Feed Fe2O3/ % | 0.7 | 1.2 | 0.8 | 1.3 |
| E1 Fe2O3/ % | 0.8 | 1.1 | 1.1 | 1.5 |
| E2 Fe2O3/ % | 0.6 | 1.2 | 0.5 | 1.1 |
| Feed CaO/ % | 41.4 | 35.5 | 41.7 | 35.2 |
| E1 CaO/ % | 41.4 | 33.2 | 37.1 | 25.4 |
| E2 CaO/ % | 43.9 | 42.1 | 46.7 | 48.9 |
| Feed CaCO3/ % | 73.82 | 63.41 | 74.35 | 62.77 |
| E1 CaCO3/ % | 73.91 | 59.30 | 66.26 | 45.25 |
| E2 CaCO3/ % | 78.27 | 75.10 | 83.37 | 87.33 |
| Feed MgO/ % | 1.8 | 1.6 | 1.7 | 1.7 |
| E1 MgO/ % | 1.6 | 1.4 | 1.8 | 1.4 |
| E2 MgO/ % | 1.5 | 2.1 | 1.7 | 2.1 |
| Feed K2O/ % | 0.3 | 0.6 | 0.2 | 0.5 |
| E1 K2O/ % | 0.4 | 0.6 | 0.3 | 0.9 |
| E2 K2O/ % | 0.1 | 0.3 | 0.2 | 0.2 |
| Feed SiO2/ % | 17.4 | 30.2 | 17.4 | 30.4 |
| E1 SiO2/ % | 18.6 | 34.0 | 24.9 | 46.2 |
| E2 SiO2/ % | 3.4 | 16.6 | 8.6 | 6.4 |
| Feed Na2O/ % | 0.9 | 0.6 | 0.8 | 0.6 |
| E1 Na2O/ % | 0.8 | 0.6 | 0.8 | 0.9 |
| E2 Na2O/ % | 2.8 | 0.2 | 0.7 | 0.2 |
| Feed Cl/ % | 0.3 | N/A* | 0.2 | 0.0 |
| E1 Cl/ % | 0.2 | N/A* | 0.2 | 0.1 |
| E2 Cl/ % | 3.2 | N/A* | 0.2 | 0.1 |
| SiO2 Rejection/ % | 98 | 88 | 60 | 85 |
| Product SiO2/ % | 3 | 17 | 9 | 6 |
| Ambient RH /% | 29 | 19 | 24 | 25 |
| Top Electrode | POS | POS | NEG | NEG |
| Top Belt Direction | E1 | E1 | E2 | E2 |
| Applied Electrode | 5 | 5 | 8 | 8 |
| Voltage /kV | | | | |
| Top Current /mA | 0.0 | 0.0 | 1.0 | 1.0 |
| Bot. Current /mA | 0.0 | 0.1 | 1.0 | 1.0 |
| Electrode gaps /Mil | 400 | 400 | 400 | 400 |

N/A* indicates value less than or equal to 0.01.wt %.

Both Sample 1 and 2 showed evidence of effective particle charging and separation in both the milled and unmilled states, indicating that such sands were good candidates for electrostatic separation techniques. The measured SiO₂ and CaO (equivalent to un-calcined CaCO₃) contents indicated that CaCO₃ was preferentially concentrated to Product End 2 (E2), while silica was preferentially concentrated (i.e. preferentially rejected) to Product End 1 (E1).

Optimum triboelectrostatic separation of CaCO₃ and SiO₂ using the X3.7 Separator was achieved for milled Sample 2, employing a negative top electrode and applied electric field voltage of 8 kV. CaCO₃ was beneficiated to 87.33 wt. % from a feed content of 62.77 wt. %, with SiO₂ content reduced to 6.4 wt. % from a feed content of 30.4 wt. %. Further improvements to separation results were expected when parameters were further optimized for increased sample throughputs, with reduced particle size shown to improve triboelectrostatic separation efficiency.

XRF analysis of the separated, beneficiated stream with increased calcium carbonate content also confirmed the presence of minerals useful for cement clinker raw meal, including alumina, iron oxide and magnesium oxide among others.

Variations and modifications may be made to the parts previously described without departing from the spirit or ambit of the disclosure.

In the claims which follow and in the preceding description, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the method and system.

Various modifications and variations of the present invention will be apparent to those skilled in the art without departing from the scope and spirit of the invention. Although the invention has been described in connection with specific preferred embodiments, it should be understood that the invention as claimed should not be unduly limited to such specific embodiments. Indeed, various modifications of the described modes for carrying out the invention which are obvious to those skilled in chemistry or related fields are intended to be within the scope of the following claims.

1. A method for reducing the amount of silica in a desert sand of a type that also comprises calcium carbonate, iron oxide and alumina components, to thereby produce a cement raw material feedstock, the method comprising:
imparting a net negative electrical charge to a silica component and a net positive electrical charge to a calcium carbonate component of the desert sand through interparticle friction by a triboelectrostatic mechanism; and
applying an electric field to the charged components of the desert sand by a triboelectrostatic mechanism;
such that the negatively charged silica component is separated from a remainder of the components of the desert sand to thereby produce the cement raw material feedstock.

2. A method according to claim 1, wherein the desert sand is a naturally occurring desert sand, such as a sand typically occurring in arid deserts having a Köppen climate classification of BWh.

3. A method according to claim 1, wherein the imparting of the electrical charge by interparticle friction and the application of the electric field occurs concurrently in a conveying triboelectrostatic separation stage.

4. A method according claim 1, wherein the triboelectrostatic mechanism by which the electric field is applied to the charged components of the desert sand, comprises an active positive electrode and an active negative electrode.

5. A method according to claim 3, wherein the conveying triboelectrostatic separation stage comprises a belt-type triboelectrostatic separation stage.

6. A method according to claim 3, wherein the triboelectrostatic separation stage comprises a plurality of triboelectrostatic separation stages.

7. A method according to claim 6, wherein the plurality of triboelectrostatic separation stages are arranged in series and/or in parallel.

8. A method according to claim 4, wherein the voltage applied to each electrode to produce the electric field does not exceed 10 kV.

9. A method according to claim 1, the method further comprising a comminution step.

10. A method according to claim 9, wherein the comminution step is carried out prior to reducing the amount of silica in the desert sand.

11. A method according to claim 1, wherein the method further comprises imparting additional electrical charge to the silica component and to the calcium carbonate component by passing the desert sand through a fluidized bed reactor, a cyclone apparatus or another apparatus for generating interparticle friction within the desert sand.

12. A method according to claim 1, wherein the desert sand comprises iron oxide in an amount, by weight, greater than about 0.5%.

13. A method according to claim 1, wherein the desert sand comprises alumina in an amount, by weight, greater than about 1%.

14. A method according to claim 1, wherein one or more parameters relating to the composition of the desert sand and/or the cement raw material feedstock is/are measured, with the measurement of the one or more parameters used to determine a set of optimum parameters for the separation of the silica component from the remainder of the components of the desert sand.

15. A method according to claim 14, wherein the one or more parameters relates to the silica component of the desert sand and/or the cement raw material feedstock.

16. (canceled)

17. A method according to claim 14, wherein the one or more parameters is measured by X-ray fluorescence or X-ray diffraction.

18. A cement raw material feedstock comprising calcium carbonate, iron oxide and alumina components, produced by the method as set forth in claim 1.

19. Use of a desert sand of a type that also comprises calcium carbonate, iron oxide and alumina components for the production of a cement raw material feedstock, wherein, prior to producing the cement raw material feedstock, the amount of silica in the desert sand is reduced according to the method of claim 1.
